(19) United States
(12) Patent Application Publication
(10) Pub. No.: US 2009/0040049 A1
(43) Pub. Date: Feb. 12, 2009

(54) Method for Processing Data Relating to a Cylinder of Fluid under Pressure

(75) Inventors: Vincent DELECOURT, Montrouge (FR); Vincent Gourlaouen, Loos (FR); Gilles Moutardier, Levallois (FR); Emilie Renouard, Paris (FR); Francois Chevalier, Evry (FR)

Correspondence Address: AIR LIQUIDE;Intellectual Property, 2700 POST OAK BOULEVARD, SUITE 1800, HOUSTON, TX, 77056, US

(73) Assignee: L'Air Liquide Societe Anonyme Pour L'Etude Et L'Exploitation Des Procedes Georges Claude, Paris (FR)

(21) Appl. No.: 12/111,582

(22) Filed: Apr. 29, 2008

(30) Foreign Application Priority Data
May 3, 2007 (FR) 0754838

(51) Int. Cl. H04Q 5/22; G08B 13/14

(52) U.S. Cl. 340/572.4; 340/10.1; 340/10.4

(57) ABSTRACT

Method for processing at least one piece of data relating to a transportable cylinder of gas under pressure or a set of cylinders of this type (pallet of cylinders), characterized in that the said method comprises stages consisting in:
transmitting a radio frequency signal containing the said data;
receiving the said radio frequency signal and extracting the said data from it;
measuring the strength of the signal received and deducing from this information about the location of the said cylinder or set of cylinders; and
processing the said data as a function of the said location information,
   the said radio frequency signal being transmitted by an electronic module fitted to the cylinder or to equipment intended to be connected to the cylinder(s), including: a valve, a regulator, and/or a gas panel.

The present application claims the benefit of priority under 35 U.S.C. § 119(a) and (b) to French Patent Application No. 0754838, filed May 3, 2007; , the entire contents of which are incorporated herein by reference.

### BACKGROUND

1. Field of the Invention

The present invention relates to a method for at least one piece of data relating to a cylinder of fluid under pressure.

The present invention has a particularly advantageous application in the area of medical or industrial fluids packed in transportable cylinders under pressure.

2. Related Art

Today there are known systems to trace individually transportable cylinders of fluid under pressure in the course of their movements, together with the data associated with these cylinders throughout the lifetime of the cylinders: from filling through to delivery, passing through distribution, maintenance, examination, and even the movement of cylinders at the client site. It is thus possible to track batches, in particular with a view to recalling a batch if necessary.

These known systems are based principally on the use of barcodes, in their most simple version, and sometimes of RFID chips (Radio Frequency IDentification) in a more sophisticated version.

It should, however, be noted that if the aim is to trace the abovementioned different stages in the life of a cylinder, it is necessary to carry out a manual reading operation, for example by means of a barcode reader put on the cylinders. This operation must be repeated for each individual cylinder, which is particularly tedious in the case of large cylinder parks.

It can also be noticed that the information associated with cylinders is generally static data, essentially identification data, such as the batch number, the cylinder identifier, filling or examination date, the type of gas, etc. The concern is therefore not with dynamic information such as the measurement of pressure or temperature, for example.

### SUMMARY OF THE INVENTION

Therefore, one aim of the present invention is to propose a method for processing at least one piece of data relating to a cylinder of fluid under pressure which acquires the data automatically, not manually as in the known systems, this acquisition being able to relate to any number of cylinders and not each cylinder individually.

This aim is attained, according to the invention, due to the fact that the said method of the present invention comprises stages consisting of:
transmitting a radio frequency signal containing the data;
receiving the radio frequency signal and extracting the data from it;
measuring the strength of the signal received and deducing from this information about the location of the cylinder; and
processing the data as a function of the location information.

In practical terms the method that is the object of the invention is implemented by means of a system for processing at least one piece of data relating to a cylinder of fluid under pressure, notable in that it comprises:
an electronic module able to transmit a radio frequency signal containing the data; and
a receiving and processing platform able to receive the radio frequency signal and extract the data from it, to measure the strength of the signal received and to deduce from this information about the location of the cylinder, and to process the data as a function of the location information.

The invention also relates to an electronic module for processing at least one piece of data relating to a cylinder of fluid under pressure, notable in that it comprises at least:
means of determining the data; and
a stage of transmitting a radio frequency signal containing the data.

Moreover, the invention can comprise the following features:
the means of determining the data comprise at least one measurement sensor;
the data being the pressure of the fluid in the cylinder, the measurement sensor is a pressure sensor;
the data being the temperature of the fluid in the cylinder, the measurement sensor is a temperature sensor;
the means of determining the data comprise at least one measurement sensor and a unit for calculating the data from the measurement provided by the sensor;
the piece of data being the quantity of fluid remaining in the cylinder, the means of determining the piece of data comprise a sensor for the pressure and a sensor for the temperature of the fluid in the cylinder, and the calculation unit is a unit that calculates the remaining quantity from the pressure and the temperature provided by the sensors;
the electronic module comprises means of comparing the data with a threshold and the means of activating an alarm depending on the result of the comparison;
the transmission stage is able to transmit a radio frequency alarm signal;
the electronic module additionally comprises, separately or in combination:
   at least one system for communicating information;
   a movement or displacement sensor;
   a brightness sensor;
   a sound sensor; and
   a radio receiving.

### BRIEF DESCRIPTION OF THE FIGURES

The following description, with regard to the appended figures, provided by way of non-limiting examples, will all it to be understood what the invention consists of and how it can be realized:

FIG. 1 is a diagram of a data-processing system according to the present invention.

FIG. 2 is a cross sectional view of a cylinder equipped with an electronic module according to the present invention.

FIG. 3 is a diagram of a variant of a data processing system according to the present invention.

### DETAILED DESCRIPTION OF THE INVENTION

In this way it will be understood that the method and the system of the invention allow automatic reception by radio frequency, on a distant and possibly centralized platform, of data relating to a park of cylinders spread over an industrial site for example, with the possibility of individually locating the cylinders on the site and therefore of having a global geographical view of the state of the park of cylinders thus supervised.

Of course, the data transmitted by radio frequency to the receiving and processing platform can concern equally the static data identifying the cylinders and dynamic data.

In particular, the invention is very interesting when the said data relates to the quantity of fluid remaining in the cylinder. Indeed, this data is closely linked with the consumption and the autonomy of the cylinder, quantities of prime importance in managing a cylinder park and which offer multiple possible applications.

To this end, the invention foresees that, the said piece of data being the quantity of fluid remaining in the cylinder, the said means of determining the said piece of data comprise a sensor for the pressure and a sensor for the temperature of the fluid in the cylinder, and the said calculation unit is a unit that calculates the said remaining quantity from the pressure and the temperature provided by the said sensors.

A first application of the invention is concerned with determining the state of cylinder stocks, consisting in locating the cylinders by fluid type, cylinder type, type of application if necessary, and displaying the quantities of fluid remaining in each of the cylinders. Among other things, this makes it possible to inventorize fixed assets, tailor stocks from one workshop to another on an industrial site, and to anticipate the replacement of cylinders in one area of the site. This also makes it possible to verify quickly the match between the available volume and production needs, and also to allocate the cylinders, in particular financially, to user service. These applications correspond in particular to the problems posed by large sites which have to manage a high number of cylinders, in different areas or factories, with different cost centres.

A second application concerns the management of resupplying in cylinders. In this case the invention foresees that the quantity of fluid remaining in the cylinder is compared with at least one threshold. The user can thus automatically know the number of cylinders to be reordered as a function of his or her needs and of the cylinders that really remain. Also in this way he or she can maintain an equivalent stock while avoiding shifts. It is even possible to imagine automatic ordering being carried out on the basis of the data received. In order to make this system for managing resupply secure, the invention foresees that an alarm is generated if the quantity remaining in the cylinder is below the said threshold.

A third application concerns tracking the consumption of the fluid contained in the cylinders. Indeed, the access to the level remaining in cylinders allows the real consumption of fluid to be tracked, which makes it possible to calculate the cost of fluid for a given piece of manufacturing and, secondly, allows the productivity of operators to be checked and the adjustments pertaining to this manufacturing to be optimized.

A fourth application concerns the sending of relevant information to equipment that is linked with the cylinder. It is actually a matter of producing an “equipment-cylinder” pair. Indeed, in the course of its use and its refilling a cylinder is very often connected to a piece of equipment, a machine, etc. It is therefore advantageous to create a communicative link between the cylinder and this equipment. Numerous uses can be envisaged if the cylinder communicates its data (gas, pressure, temperature, autonomy, etc.) to the equipment to which it is connected and vice versa. Among these possible uses, the following can be cited:
the exchanges between the cylinder and the analyser in the context of the “gas and laboratories” market;
the use of gas such as Aligal® in the agri-food field;
the conditioner-cylinder interfacing in refilling operations. Indeed the process of refilling a cylinder may be different from one cylinder to the next and should respond to criteria of varying strictness. An interface between cylinder and conditioning system allows verification that the cylinder is properly full, has been properly refilled by the right system and indeed contains the right fluid.
the interfacing between cylinder and fuel cell. The cylinder can communicate its remaining autonomy or other data to the fuel cell; and
in the welding/cutting field knowing the volume or the consumption profile per workplace is a particularly pertinent piece of data for optimizing the procedure and costs. It is envisaged, in particular, to interface such a system with the existing solutions for tracking and optimizing the productivity of a welding workshop.

A fifth application of the invention concerns invoicing for the consumption of the fluid contained in the cylinders. It is possible to imagine, for example, invoicing for hiring the cylinder by the hour with a chronometric counter integrated into the electronic module on the cylinder. This chronometer would be activated from the arrival of the cylinder with the client and would stop as soon as it comes back from there again. It is possible to imagine invoicing linked to the use of the gas by the client (invoicing per kWh for hydrogen for example, invoicing per hour of welding, etc.), in each case thanks to appropriate instrumentation on the cylinder.

According to a particular embodiment of the invention, the said electronic module is fitted to the cylinder. However, the invention also foresees that the electronic module is fitted to equipment intended to be connected to the cylinder. What makes this arrangement especially advantageous is the fact that it is not necessary in this case to equip all the cylinders with an electronic module; it suffices to do this only on fixed pieces of equipment such as valves etc.

In practice the on-board electronic module can be adapted equally well to cylinder regulators and to gas panels. Current re-supply and tracking systems of gas panels have a wire pressure sensor connected to a software application, making available the data necessary for re-supply. Equipping these panels with an electronic module conforming to the invention allows wire systems, which are costly and complicated to install, to be done away with.

The invention can comprise all or part of the following features:
the said radio frequency signal is transmitted by an electronic module fitted to the cylinder;
the said radio frequency signal is transmitted by an electronic module fitted to equipment intended to be connected to the cylinder;
the said data relates to the quantity of fluid remaining in the cylinder;
the said data relating to the quantity of fluid remaining is compared to at least one minimum threshold;
an alarm is activated if the quantity of fluid remaining in the cylinder is less than the said minimum threshold;
the radio frequency signal is transmitted automatically after a given period; and
the radio frequency signal is transmitted on alarm.

The method can be applied:
to determining the state of stocks of cylinders of fluid under pressure;
to managing the re-supply of cylinders of fluid under pressure;
to tracking the consumption of fluid contained in the cylinders of fluid under pressure;
to sending information to a piece of equipment linked to the said cylinder of fluid under pressure;
to invoicing the consumption of fluid contained in the cylinders of fluid under pressure.

The invention also relates to a system comprising:
an electronic module able to transmit a radio frequency signal containing the said piece of data;
a receiving and processing platform able to receive the said radio frequency signal and to extract the said data from it, to measure the strength of the signal received and to deduce from this information about the location of the said cylinder, and to process the said data as a function of the said location information;
the said electronic module is fitted to the cylinder; and
the said electronic module is fitted to equipment intended to be connected to the cylinder.

For a further understanding of the nature and objects for the present invention, reference should be made to the detailed description, taken in conjunction withteh accompanying figures, in which like elements are given the same or analogous reference numbers and wherein:

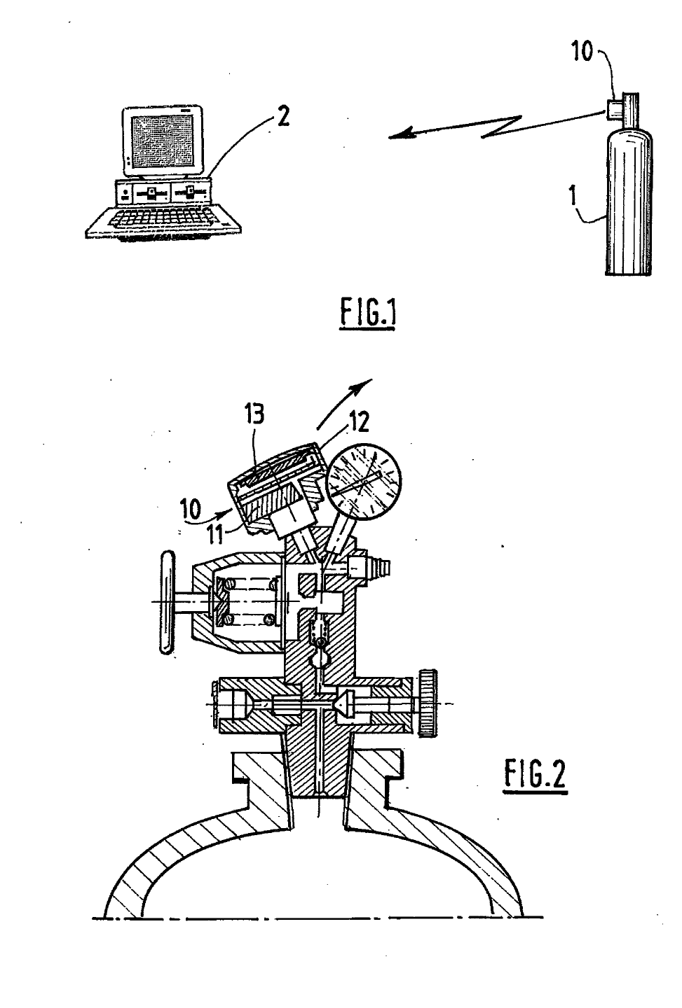

FIG. 1 shows in a schematic manner a system for processing at least one piece of data relating to a cylinder 1 containing a fluid under pressure, such as a gas with an industrial or medical application. It will be recalled that two types of possible data exist: data termed static, that is data relating to a state of the cylinder or of the fluid under pressure that it contains (example: batch number, cylinder identifier, expiry date, etc.), which are data that can evolve in the course of time, on the condition that a data-update operation is carried out in the system; and data termed dynamic, that is data linked with the measurement of a physical quantity of the fluid under pressure contained in the cylinder, such as the pressure and temperature, data updated automatically at the sampling frequency of the sensors on board the cylinder.

This system is composed of two principal entities, namely an electronic module 10 able to measure physical quantities, record them, and transmit a radio frequency signal containing the said data, and a receiving and processing platform 2.

It will be noted that in FIG. 1 the electronic module is fitted to the cylinder 1. However, as mentioned above, the same module may equip not the cylinder itself, but a connection element to which the cylinder would be linked.

The electronic module 10 comprises means of determining the (piece of) data to be transmitted to the platform 2. These means may be sensors directly measuring the data, such as pressure or temperature sensors for example. But the piece of data may also be determined by calculation from the measured data, such as the quantity of fluid remaining in the cylinder, which can be deduced from measurements of pressure and temperature. In this latter case, the module 10 comprises a calculation unit, such as a microprocessor integrated in an electronic card 11, as indicated in FIG. 2. The electronic card 11 also comprises a stage for transmitting a radio frequency signal. An electrical supply system 12 having no wire, battery, photovoltaic cell or inductive system, is provided in the electronic module 10 to supply the card 11, together with a display 13, for example a liquid crystal display.

The electronic module 10 may automatically transmit the radio frequency signal regularly after a given period of time. This signal may also be transmitted as soon as an alarm is activated, when for example the quantity of fluid remaining in the cylinder 1 is below a given threshold. To this end, the module 10 comprises means of comparing the said piece of data to a threshold and the means of activating an alarm depending on the result of the said comparison. The alarm signal is sent to the platform 2 which, thus informed of the situation, can take all the necessary steps.

The electronic module 10 may integrate diverse other components, not shown:
systems for communicating information, such as indicator lights, a warning sound or a loudspeaker;
a movement or displacement sensor;
a light or sound sensor;
one or more buttons of the acquisition interface; and
a radio receiving.

The platform 2 also has means for measuring the strength of the radio frequency signal received, also called RSSI (Received Signal Strength Indication), and this with the aim of obtaining information about the location of the cylinder and of enriching the processing of the (piece of) data extracted from the radio frequency signal by integrating this complementary information therewith.

This measurement allows it to be deduced in which area of coverage the cylinder is located. If the data of a cylinder are only received by a single receiving, it means that this cylinder is located in the area of the receiving, that is, within the perimeter of radio coverage of the receiving. Conversely, if the data of a cylinder are received by several receivings, the RSSI will be a great help, because it will allow the area in which the cylinder is really situated to be deduced, namely in the area of the receiving that receives the highest RSSI.

The platform 2 also comprises the usual means for receiving the radio frequency signal transmitted by the electronic module 10 and means of extracting the (piece of) data contained in this signal so as to process them in a manner conforming to the use intended to be made of them; in this respect, reference will be made to the numerous examples of application provided above.

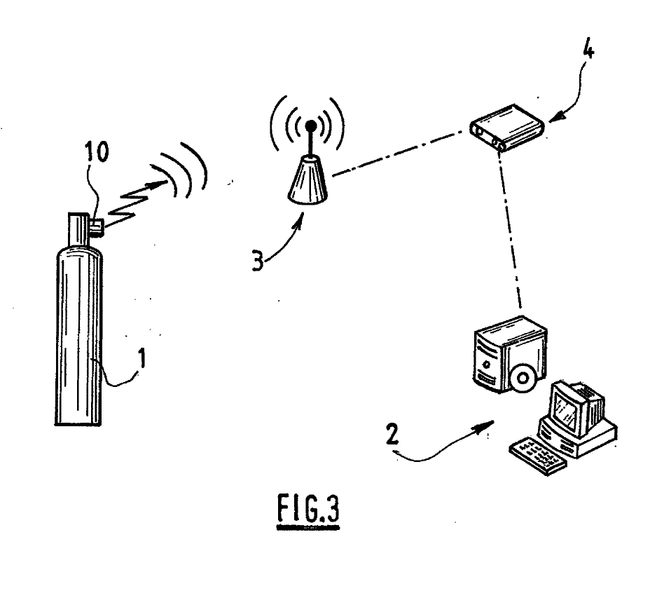

In the variant of FIG. 3, the electronic module 10 of the cylinder 1 communicates with the control platform 2 (for example, a computer) via an antenna 3 and a receiving 4 connected with the antenna. The link between the receiving 4 and the control instrument 2 may be wireless or by wire.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method for processing at least one piece of data relating to a transportable cylinder of gas under pressure or a set of cylinders of this type (pallet of cylinders), wherein the method comprises the following stages:
transmitting a radio frequency signal containing the data;
receiving the radio frequency signal and extracting the data from it;
measuring the strength of the signal received and deducing from this information about the location of the cylinder or set of cylinders; and
processing the data as a function of the location information; the radio frequency signal being transmitted by an electronic module fitted to the cylinder or to equipment intended to be connected to the cylinder(s), including: a valve, a regulator, and a gas panel.

2. The method of claim 1, wherein the data relates to the quantity of fluid remaining in the cylinder(s).

3. The method of claim 2, wherein the data relating to the quantity of fluid remaining is compared to at least one minimum threshold.

4. The method of claim 3, wherein an alarm is activated if the quantity of fluid remaining in the cylinder(s) is less than the minimum threshold.

5. The method of claim 1, wherein the radio frequency signal is transmitted automatically after a given period.

6. The method of claim 1, wherein the radio frequency signal is transmitted on alarm.

7. The method of claim 1, wherein the method is used to determine the state of stocks of cylinders of fluid under pressure.

8. The method of claim 4, wherein the radio frequency signal is transmitted automatically after a given period.

9. The method of claim 8, wherein the radio frequency signal is transmitted on alarm.

10. The method of claim 9 wherein the method is used to determine the state of stocks of cylinders of fluid under pressure.

11. The method of claim 1, wherein the method is used to manage the re-supply of cylinders of fluid under pressure.

12. The method of claim 1, wherein the method is used to track the consumption of fluid contained in the cylinders of fluid under pressure.

13. The method of claim 1, wherein the method is used to send information to a piece of equipment linked to the said cylinder of fluid under pressure.

14. The method of claim 1, wherein the method is used to invoice for the consumption of fluid contained in the cylinders of fluid under pressure.

15. The method of claim 9 wherein the method is used to manage the re-supply of cylinders of fluid under pressure.

16. The method of claim 9 wherein the method is used to track the consumption of fluid contained in the cylinders of fluid under pressure.

17. The method of claim 9 wherein the method is used to send information to a piece of equipment linked to the said cylinder of fluid under pressure.

18. The method of claim 9 wherein the method is used to invoice for the consumption of fluid contained in the cylinders of fluid under pressure.

19. A system for processing at least one piece of data relating to a transportable cylinder of gas under pressure, wherein said system comprises:
an electronic module able to transmit a radio frequency signal containing the piece of data;
a receiving and processing platform designed to receive the radio frequency signal and to extract the data from the signal, to measure the strength of the signal received and to deduce from this information about the location of the cylinder(s), and to process the data as a function of the location information, the electronic module being fitted to the cylinder(s) or to equipment intended to be connected to the cylinder(s), including: a valve, a regulator, and a gas panel.
